(19) United States
(12) Patent Application Publication
(10) Pub. No.: US 2021/0155334 A1
(43) Pub. Date: May 27, 2021

(54) Land Power Connection For Container Ships

(71) Applicant: Hans-Erhard Schmidt, Melbeck (DE)

(72) Inventor: Hans-Erhard Schmidt, Melbeck (DE)

(21) Appl. No.: 17/054,216

(22) PCT Filed: May 9, 2019
(86) PCT No.: PCT/EP2019/061965

§ 371 Date: Jan. 25, 2021

(30) Foreign Application Priority Data
May 11, 2018 (DE) 10 2018 003 806.9

(51) Int. Cl. B63J 3/00; E02B 3/20

(52) U.S. Cl. CPC B63J 3/00; B63J 2003/043; E02B 3/20

(57) ABSTRACT

A device for establishing an electrical connection between a multiphase distribution grid of a ship and a multiphase supply grid on the land, having an electrical plug unit arranged on the ship and an electrical coupling unit arranged on the land for making electrical contact with the electrical plug unit of the ship, wherein the electrical coupling unit arranged on the land is designed to be able to be moved along at least a partial region of the ship. To create a device for establishing a land power connection of a ship that allows rapid and flexible establishment of electrical contact, it is proposed according to the invention for the electrical coupling unit on the land to be designed to be able to be moved in a manner guided by rails, wherein the electrical coupling unit on the land has a reception and guidance device for the wired plug of the electrical plug unit of the ship.

### TECHNICAL FIELD

The invention relates to a device for establishing an electrical connection between a multiphase distribution grid of a ship and a multiphase supply grid on land, having an electrical plug unit arranged on the ship and an electrical coupling unit arranged on land for making electrical contact with the electrical plug unit of the ship, wherein the electrical coupling unit arranged on land is designed to be able to be moved along at least a partial region of the ship.

### BACKGROUND

To maintain the power supply on board a ship, it is customary, even in ships anchored in port, to operate diesel engines to generate power. Diesel engines of container ships comprise not only high fuel consumption, but also have considerable environmental impact because of nitrous oxide and soot emissions. Because of stricter environmental protection laws as well as the fact that individual port operation companies are planning to ban the use of ships' diesel motors to generate power in ports, power generation on land for ships anchored in port is steadily becoming more important, replacing the use of ships' diesel engines.

Because the supply grid on land and the distribution grids of ships can have different frequencies, neutral point treatments and the like, the connection between the two distribution grids can be established by way of a frequency converter.

Patent DE 2009 015 603 B4 disclosed a power connection on land for cruise ships in which a plug unit on land can be brought all the way to the coupling unit on board the ship by means of a telescopable joint crane to make it possible to establish the electrical contact between the two distribution grids.

Contrary to the configuration on cruise ships, in which the electrical coupling unit is arranged on board, in container ships the electrical plug unit is on the ship, usually in a container, and must be connected with an electrical coupling unit on land. The electrical plug unit on the ship consists essentially of two electrical cables, which are wound up on a common cable drum and which are equipped with plugs at their ends. In parallel motion the two cables are unwound from a cable drum and/or wound up again on it.

To provide the coupling unit on land, it is common practice in port facilities in the USA to arrange the coupling units in grooves or channels that are formed in the wall of the dock and can be covered by means of massive steel plates.

Container ships vary so much in length and containers can be arranged with the electrical plug units at different positions on the ship, and in addition a ship's mooring position on the dock wall can vary. For these reasons, it is indispensable to provide several of these channels equipped with electrical coupling units in the dock wall. Transporting the cable that is lowered from a container ship to an electrical coupling unit several meters away is extremely problematic, because each plug weighs approximately 15 kg and each cable connected to the plug weighs about 10 kg more per linear meter.

This known installation of electrical coupling units in channels configured in the dock wall is highly complex because of the number of channels and coupling units required, and in addition involves considerable investment costs. Moreover, it is questionable whether the configuration of channels in the dock wall is reliable at all points, because the channels can affect static in the dock wall.

In addition, from Igus GmbH, the e-Chain® reel system is known, in which the coupling unit on land is arranged on a movable roller wagon, which is connected with a supply grid on land by way of a mounted conductor line. The roller wagon equipped with the coupling unit is moved along the side of a ship by means of a separate vehicle, for instance a lift truck.

This known system makes possible a flexible adjustment of the electrical coupling site to the ship's respective transfer point; however, this configuration has disadvantages: first, the fact that the roller wagon can move on the dock wall without any kind of guidance or fastening and, second, that the connector line coupled with the roller wagon is freely contiguous with the dock wall during operation, a situation that, besides the danger of mechanical damage to the conductor line, presents a considerable operating risk owing to the danger of tripping.

### SUMMARY

Consequently, it is the object of the invention to provide a device for establishing an electrical connection between a multiphase distribution grid of a ship and a multiphase supply grid on land, making possible the rapid, safe and flexible establishment of electrical contacting.

This object is achieved according to the invention in that the electrical coupling unit on land is configured so that it can be moved on tracks, wherein the electrical coupling unit on land comprises an intake and guidance device for the cable-connected plug of the ship's electrical plug unit.

The inventive configuration of the coupling unit as a coupling unit that can be moved on tracks along the ship has the advantage that the coupling unit can be guided along the dock wall in a fixed position by means of the track system. Thus, it is possible in a simple way to position the coupling unit with respect to the ship precisely at the site on which the plugs of the plug unit of the ship are lowered. All that's required now to effect the electrical contact between the distribution grid of the ship and the land distribution grid is to insert the two plugs of the ship's plug unit into corresponding plug couplings of the coupling unit on land.

The intake and guidance device of the coupling unit serves to assure that the heavy cable-connected plugs of the plug unit can be fed to the plug couplings of the coupling unit, as far as possible without manual manipulation.

For configuring the track system of the coupling unit, which is designed to be movable on tracks, it is proposed with the invention that tracks of the electrical coupling unit that is movable on tracks, should be mounted on the dock wall or on a high-water-protection wall mounted on the dock wall.

To avoid hindrance to the mooring and launching of the ship, it is proposed according to a practical embodiment of the invention that the track system should be configured to be interrupted in the area of the securing of a ship and in the area of protective gates, but should be traversable by the electrical coupling unit.

To configure the track system, according to a first embodiment of the invention, it is proposed that the track system should consist of two tracks arranged parallel alongside one another on which the coupling unit can be moved by means of a roller system that engages or interlocks with the tracks. This embodiment of the track system is particularly suitable in the event that the movable coupling unit is mounted on a high-water-protection wall that is mounted on the dock wall and thus the tracks of the track system do not cause stumbling on the dock wall.

With a second inventive embodiment for configuring the track system, it is proposed that the track system should consist of a lateral guidance track along which the coupling unit can be moved by means of a roller system mounted on the dock wall or on the high-water-protection wall. The guidance track standing vertically on the dock wall, viewed in cross-section of the dock wall, is mounted on land in front of the bollards for securing ships. In this track system too, the guidance tracks are interrupted in the immediate vicinity of the bollards, so that the securing points, in particular the bollards, both on land and on water, are freely accessible.

The power drive of the movable coupling unit is configured according to the invention in such a way that the track system comprises at least one toothed rack or sprocket track, along which the coupling unit can be moved by means of at least one power-operated sprocket.

In addition, it is proposed with the invention that the distance between individual rollers of the roller system in the driving direction should be configured so that, with at least four rollers arranged in single file, at least three rollers are always in contact with the tracks or the high-water-protection wall. In this way it can be assured that the movable coupling unit is always operated with sufficient stability even in traversing a gap in the track system.

In configuring the intake and guidance device, it is proposed that the intake and guidance device should comprise a guide rail that is of semicircular cross-section for each cable-connected plug of the electrical plug unit, wherein each guide rail comprises two portions arranged at an angle to one another, which are connected radially with one another. Advantageously, the two portions of each guide rail should be arranged at an angle to one another of 70° to 110°, that is, basically at a right angle.

The intake and guidance device functions in such a way that, as soon as the cable-connected plugs of the plug unit are placed in the respective guide rails, the rails are self-activated and pushed along the guide rail by the particular weight of the cables that follow, to reach the plug coupling of the coupling unit, without requiring any manual assistance.

In order to facilitate insertion of the cable-connected plugs of the plug unit into the guide rail of the intake and guidance device, it is further proposed with the invention that each guide rail should comprise an area that is aligned vertically upwards, wherein at the free upper end of every vertical area, a sleeve that widens in funnel shape toward the top is mounted for the guidance and intake of each plug of the electrical plug unit. The funnel-shaped sleeve, in addition, serves to hold in place a securing cap, which loosely surrounds the individual plugs of the plug unit to protect them from damage as they are being lowered from the ship.

Finally, it is proposed with the invention that the coupling of the movable coupling unit is performed at a supply grid connection on land, by at least one flexible guidance chain. The guidance chain, advantageously to be made of stainless steel, provides good protection of the electrical cable that is fed through the guidance chain.

Additional features and advantages of the invention can be seen from the related drawings, in which three embodiments of an inventive device for establishing an electrical connection between a multiphase distribution grid of a ship and a multiphase supply grid on land are presented only by way of example, without restricting the invention to those embodiments.

### BRIEF DESCRIPTION OF THE DRAWINGS

FIG. 1 shows a schematic depiction of an inventive device for establishing an electrical connection.

FIG. 2 shows a side view of the movable coupling unit according to FIG. 1, depicting a first embodiment of the coupling unit.

FIG. 3 shows a side view of a second embodiment of the movable coupling unit.

FIG. 4 shows a schematic section along the line IV-IV according to FIG. 3.

FIG. 5 shows a schematic side view of the movable coupling unit according to FIG. 3 and FIG. 4, depicting the traversing of a gap in the track.

FIG. 6 shows a schematic sectional depiction according to FIG. 4, but depicting a third embodiment of the movable coupling unit.

### DETAILED DESCRIPTION

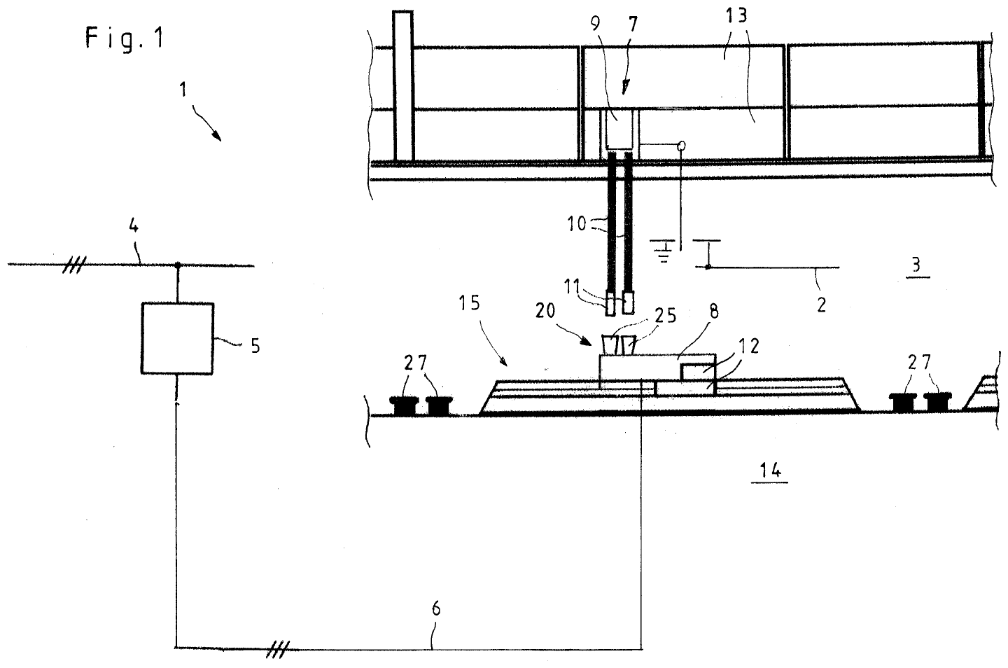

The schematic illustration in FIG. 1 shows the structure of a device 1 for establishing an electrical connection between a multiphase distribution grid 2 of a ship 3 and a multiphase supply grid 4 on land.

Because of tighter environmental protection laws, power supply on land for ships 3 anchored in a port has assumed more and more importance, because power supply on land allows diesel engines of ships 3 to be dispensed with.

Because the supply grid 4 on land and the distribution grids 2 of ships 3 can have different frequencies, neutral point treatments and the like, the connection between the two distribution grids 2 and 4 can be established by way of a frequency converter 5. For the sake of simplicity, the schematic drawing shows only the frequency converter 5 without the transformers that are in place in front of and behind it. The frequency converter 5 is connected with the supply grid 2 of the ship 3 by a cable connection 6.

In container ships 3 the actual electrical contacting between the ship's supply grid 2 and the supply grid 4 on land occurs by means of an electrical plug unit 7 on board the ship 3 and an electrical coupling unit 8 on land, which are connected with one another. The electrical plug unit 7 on the ship consists essentially of two electrical cables 10 that are wound on a common cable drum 9 and are provided at the ends with plugs 11. The two cables, in parallel, are unwound from the cable drum 9 and/or are wound up onto it again. For insertion of the plug 11 of the plug unit 7, the coupling unit 8 is equipped with two corresponding plug couplings 12. The plug unit 7 on the ship is, as a rule, incorporated in a container 13, as illustrated in FIG. 1.

To make the contacting between the ship's plug unit 7 and the coupling unit 8 on land as simple as possible, the electrical coupling unit 8 established on land is designed as movable on a dock wall 14 along at least a portion of the ship 3.

The configuration of the electrical coupling unit 8 to be movable along the ship 3 is advantageous because container ships 3 can have the most varying lengths, containers 13 can be configured with the electrical plug units 7 at different positions on the ship 3, and also the securing position of a ship 3 on the dock wall 14 can vary. Manual transport of the cables 10 that have been lowered from a container ship 3 to an electrical coupling unit 8 several meters away is extremely problematic, because each plug 11 weighs approximately 15 kg and each cable 10 connected to the plugs 11 weighs about 10 kg more per linear meter.

Because the coupling unit 8 is configured as a coupling unit 8 that can be moved along the ship 3, it is a simple matter to position the coupling unit 8 precisely in relation to the ship 3 at the position at which the plugs 11 of the ship's plug unit 7 are lowered. To perform the electrical contacting of the distribution grid 2 of the ship 3 and the distribution grid 4 on land, it is now necessary only to insert the two plugs 11 of the ship's plug unit 7 into corresponding plug couplings 12 of the coupling unit 8 on land.

The device 1 for electrical contacting requires only one operating person, thanks to the precise positioning capability of the electrical coupling unit 8 in relation to the ship 3 or to the electrical plug unit 7 of the ship 3.

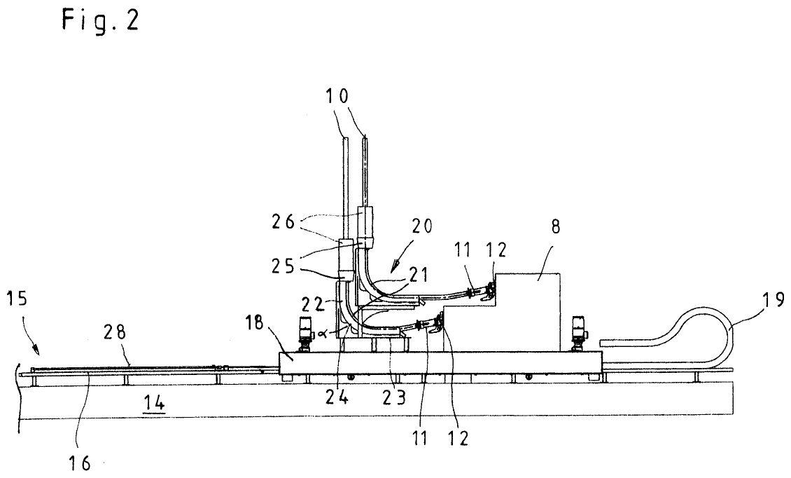

In the first embodiment as illustrated in FIG. 1 and FIG. 2 for configuring the movable electrical coupling unit 8, the coupling unit 8 is portrayed as movable and controllable on tracks, wherein a track system 15, consisting of two tracks 16 mounted parallel to one another, is mounted directly on the dock wall 14 or at a slight distance on the dock wall 14. The coupling unit 8 can be moved along the track system 15 by mean of a roller system 17 that engages with the tracks 16, wherein the coupling unit 8 in the illustrated embodiments is mounted on a sled 18 that can move along the track system 15.

The cable connection 6, by which the movable coupling unit 8 is connected with the frequency convertor 5, runs in a flexible guidance chain 19 in the area of the track system 15 of the movable coupling unit. The guidance chain 19, advantageously to be made of stainless steel, constitutes good protection for the cable connection 6 that is fed through the guidance chain 19.

As can be seen from FIG. 2, the electrical coupling unit 8 comprises an intake and guidance device 20 for the cable-connected plugs 11 of the electrical plug unit 7 of the ship 3, in order to allow the heavy cable-connected plugs 11 of the plug unit 7, as much as possible without manual action, to be fed to the plug couplings 12 of the coupling unit 8.

For every cable-connected plug 11 of the electrical plug unit 7, the intake and guidance device 20 comprises a guide rail 21, which is of semicircular cross-section, wherein each guide rail 21 comprises two portions 22, 23 situated at an angle α to one another, which are connected with one another by a radius 24. The two portions 22, 23 of each guide rail 21 are positioned with respect to one another at an angle α between 70° and 110°, or essentially at a right angle to one another.

In order to facilitate insertion of the cable-connected plugs 11 of the plug unit 7 into the guide rails 21 of the intake and guidance device 20, each guide rail 21 comprises a portion 22 that is aligned vertically upward, wherein at the free upper end of every vertical area 22, a sleeve 25 that widens toward the top in funnel shape is mounted for the guidance and intake of each plug 11 of the electrical plug unit 7. Advantageously, in addition, the funnel-shaped sleeve 25 serves to hold in place a securing cap 26, which loosely surrounds the individual plugs 11 of the plug unit 7 to protect them from damage as they are being lowered from the ship 3.

The intake and guidance device 20 operates in such a way that, as soon as the cable-connected plugs 11 of the plug unit 7 have been inserted in the respective guide rails 21, the latter, by the particular weight of the cables 10 that follow, are pushed independently along the guide rails 21 to the plug coupling 12 of the coupling unit 8, without any need of manual assistance.

However, the plugs 11 are inserted manually into the plug couplings 12 of the coupling unit 8 by the sole service person for the movable coupling unit 8.

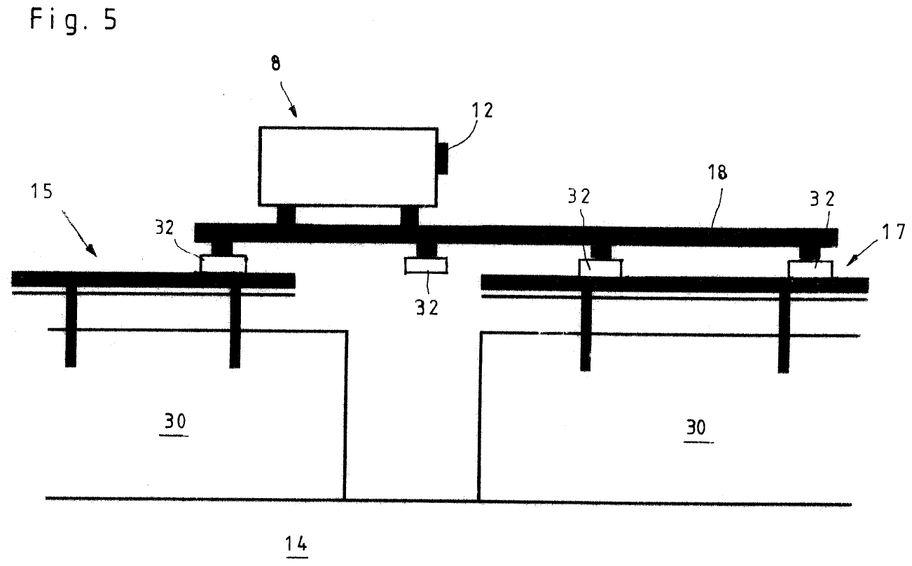

As can further be seen from FIG. 1 and FIG. 2, the track system 15 is configured with an interruption in the area of the bollards 27 for securing the ships 3 as well as in the area of protective gates, in order to avoid hindering the launching and mooring of the ship 3. The movable coupling unit 8, however, is configured so that the said gaps in the track system 15 can be traversed by the coupling unit 8, as is explained below with reference to FIG. 5.

The power drive of the movable coupling unit 8 is configured in the illustrated embodiments in such a way that the track system 15 comprises at least one toothed rack or sprocket track 28, along which the coupling unit 8 can be moved by means of at least one power-operated sprocket 29, which is engaged with the toothed rack or sprocket track 28.

Alternatively, it is also possible, of course, to configure the roller system 17 as a power-driven roller system 17.

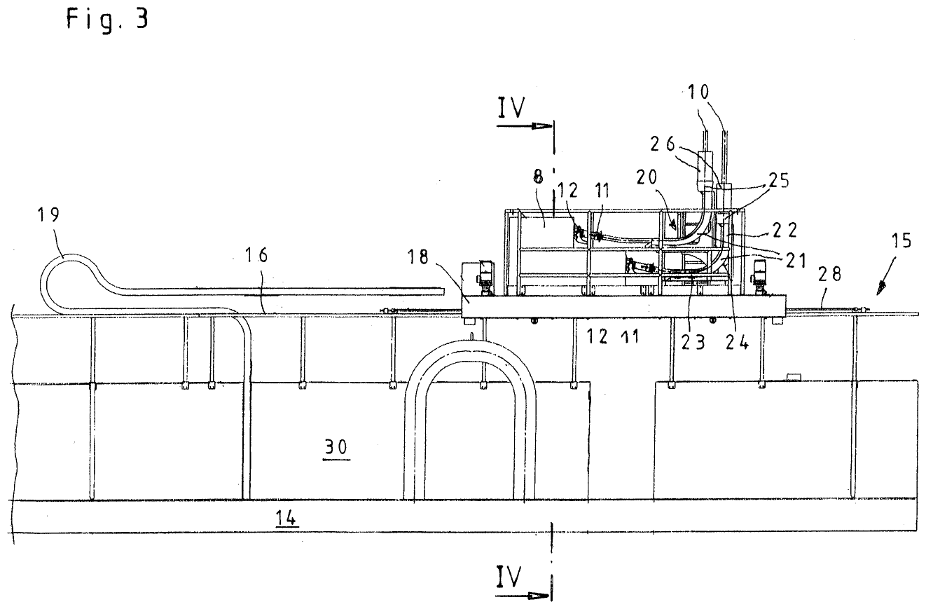

The illustrations in FIGS. 3, 4 and 5 depict a second embodiment for configuring the movable electrical coupling unit 8. In this second embodiment, the track system 15 is not mounted directly on, or at a slight distance from, the dock wall 14, but instead is arranged on a high-water-protection wall 30 on the dock wall 14. In this embodiment, as well, the track system 15 consists of two tracks 16 arranged parallel alongside one another.

Otherwise, the structure of the movable electrical coupling unit 8 corresponds to the previously described (see FIGS. 1 and 2) electrical coupling unit 8.

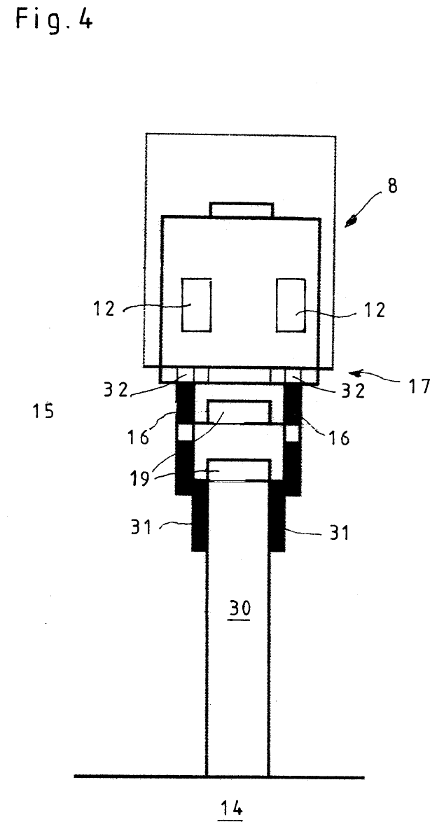

The sectional depiction according to FIG. 4 shows how the track system 15 is fastened to the high-water-protection wall 30 by lateral carriers 31. Alternatively, to the illustrated embodiment, the carriers 31 can also be configured in such a way that they stand on the dock wall 14 and have the high-water-protection wall 30 between them.

The flexible guidance chain 19 for the cable connection 6, by which the movable coupling unit 8 is connected with the frequency converter 5, is enclosed between the tracks 16 of the track system 15.

FIG. 5 depicts schematically how the movable coupling unit 8 can traverse a gap in the track system 15, as can be seen, for instance, in the area of the bollards 27 or of the protective gates in the high-water-protection wall 30, to avoid hindering the securing of ships 3 or blocking access to the protective gates.

As can be seen from FIG. 5, the distance between individual rollers 32 of the roller system 17 in the driving direction of the coupling unit 8 is configured in such a way that at least three rollers 32 are always in contact with the tracks 16. This ensures that the movable coupling unit 8 is always conducted with sufficient stability, even in traversing a gap in the track system 15.

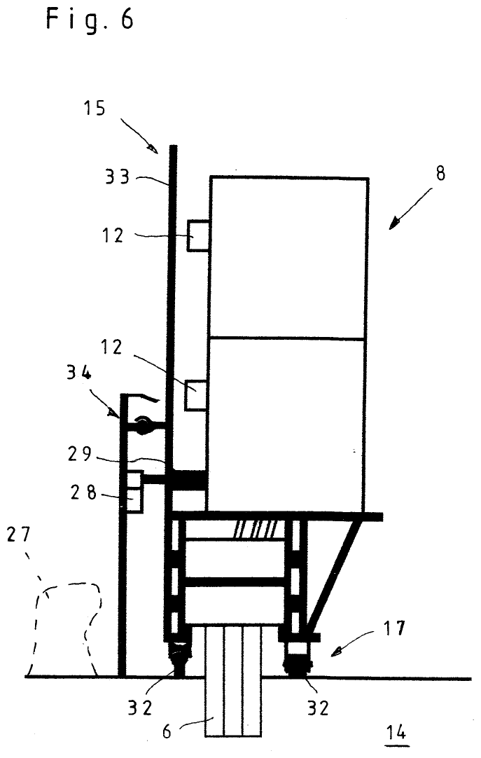

FIG. 6 shows a third embodiment of the movable coupling unit 8.

In this embodiment, the track system 15 consists of a side guidance track 33, along which the coupling unit 8 can be moved by means of a roller system 17 mounted on the dock wall 14. In this embodiment, as well, the track system 15 is interrupted in the area of the securing sites for ships 3, so that the bollards 27 both on land and on water are freely accessible.

Viewed in the cross-section of the dock wall 14 according to FIG. 6, the guidance track 33 mounted vertically on the dock wall 14 is arranged in front of the bollards 27 on land.

The movable coupling unit 8 is guided along the guidance track 33 in the illustrated embodiment by a form-locking guidance system 34, interlocked together, which is mounted both on the guidance track 33 and on the movable coupling unit 8.

In the embodiments for configuring the electrical coupling unit 8 previously described with reference to the illustrations in FIGS. 1 through 6, the said unit was always depicted as configured to be movable and guided by track.

The device 1, as described above, for establishing an electrical connection between a multiphase distribution grid 2 of a ship 3 and a multiphase supply grid 4 on land, is distinguished in that the coupling unit 8 is configured as movable and guided by track alongside the ship 3, so that it is possible in a simple manner to position the coupling unit 8 with precision in relation to the ship 3 at the site at which the plugs 11 of the ship's plug unit 7 are lowered.

1. A device for establishing an electrical connection between a multiphase distribution grid of a ship and a multiphase supply grid on land, having an electrical plug unit arranged on the ship and an electrical coupling unit arranged on land for making electrical contact with the electrical plug unit of the ship, wherein the electrical coupling unit arranged on land is designed to be able to be moved along at least a partial region of the ship,
wherein the electrical coupling unit on land is configured so that it can move with guidance by tracks, wherein the electrical coupling unit on land comprises an intake and guidance device for the cable-connected plugs of the electrical plug unit of the ship.

2. The device according to claim 1, wherein a track system of the electrical coupling unit on land, movable with guidance by tracks, is mounted on the dock wall or on a high-water-protection wall mounted on the dock wall.

3. The device according to claim 2, wherein the track system is configured as interrupted in the area for securing a ship as well as in the area of protective gates, but can be traversed by the electrical coupling unit on land.

4. The device according to claim 2, wherein the track system consists of two tracks aligned parallel alongside one another on which the electrical coupling unit on land can be moved by means of a roller system that engages with the tracks.

5. The device according to claim 2, wherein the track system consists of a side guidance track, along which the electrical coupling unit on land can be moved by means of a roller system mounted on the dock wall or on the high-water-protection wall.

6. The device according to claim 2, wherein the track system comprises at least one toothed rack or sprocket track along which the electrical coupling unit on land can be moved by means of a power-driven sprocket.

7. The device according to claim 4, wherein the distance between individual rollers of the roller system in the travel direction is configured in such a way that, when at least four rollers are arranged in single file, at least three rollers are always in contact with the tracks or high-water-protection wall.

8. The device according to claim 1, wherein the intake and guidance device comprises one guide rail of semicircular cross-section for each cable-connected plug of the electrical plug unit of the ship, wherein each guide rail comprises two portions mounted at an angle to one another and connected to one another by a radius.

9. The device according to claim 8, wherein the angle, at which the two portions of each guide rail are positioned with respect to one another, is between 70° and 110°.

10. The device according to claim 8, wherein each guide rail includes a portion aligned vertically upward, wherein at the free upper end of each vertical portion, a funnel-shaped sleeve, widening toward the top, is mounted for the guidance and insertion of each plug of the electrical plug unit of the ship and, in addition, the sleeve serves to retain a securing cap, which surrounds the individual plugs of the electrical plug unit of the ship as they are lowered from the ship.

11. The device according to claim 1, wherein the movable electrical coupling unit on land is electrically connected with a supply grid on land by at least one flexible guidance chain.

12. The device according to claim 3, wherein the track system consists of two tracks aligned parallel alongside one another on which the electrical coupling unit on land can be moved by means of a roller system that engages with the tracks.

13. The device according to claim 3, wherein the track system consists of a side guidance track, along which the electrical coupling unit on land can be moved by means of a roller system mounted on the dock wall or on the high-water-protection wall.

14. The device according to claim 5, wherein the distance between individual rollers of the roller system in the travel direction is configured in such a way that, when at least four rollers are arranged in single file, at least three rollers are always in contact with the tracks or high-water-protection wall.

15. The device according to claim 9, wherein each guide rail includes a portion aligned vertically upward, wherein at the free upper end of each vertical portion, a funnel-shaped sleeve, widening toward the top, is mounted for the guidance and insertion of each plug of the electrical plug unit of the ship and, in addition, the sleeve serves to retain a securing cap, which surrounds the individual plugs of the electrical plug unit of the ship as they are lowered from the ship.
